(19) United States
(12) Patent Application Publication
(10) Pub. No.: US 2009/0024301 A1
(43) Pub. Date: Jan. 22, 2009

(54) METHOD AND APPARATUS FOR SYNCHRONOUS SWITCHING OF FUEL INJECTION CONTROL SIGNALS

(76) Inventor: Orlando Volpato, Piracicaba (BR)

Correspondence Address: DELPHI TECHNOLOGIES, INC., M/C 480-410-202, PO BOX 5052, TROY, MI, 48007, US

(21) Appl. No.: 11/780,949

(22) Filed: Jul. 20, 2007

(51) Int. Cl. F02D 28/00

(52) U.S. Cl. 701/103

(57) ABSTRACT

An engine management and fuel delivery system allows an internal combustion engine to operate on liquid fuel such as gasoline, ethanol or a blend thereof, or compressed natural gas (CNG). A first set of fuel injectors is configured to deliver liquid fuel to the cylinders. A second set of fuel injectors is configured to deliver natural gas to the cylinders. An electronic controller is configured to generate fuel injection signals for one of the sets of injectors. An injector selector is configured to direct such fuel injection signals to either the first set of fuel injectors or the second set of fuel injectors based on a fuel type command. The fuel type command is indicative of a desired fuel type selected from either liquid fuel or CNG fuel. The fuel type command is synchronized in accordance with an engine crankshaft position signal in order to coordinate the switchover, for each one of the fuel injection signals, one by one, as each fuel injection event is completed.

### TECHNICAL FIELD

The present invention relates generally to internal combustion engine control systems, and more particularly to a method and apparatus for operating an internal combustion engine.

### BACKGROUND OF THE INVENTION

It is known to provide an engine control system for a modern internal combustion engine that includes an electronic controller operable to monitor engine operating conditions and operator inputs, and operable to control various systems and actuators based upon the monitored conditions and inputs. The conventional engine control system is electrically connected to a plurality of engine and vehicle sensors that monitor engine operating conditions and operator demands. Monitored operating conditions may include, for example, engine rotational speed and position, engine load, vehicle speed, engine coolant temperature, intake air temperature, engine air/fuel ratio, accessory demands, and the operator's demand for power. The engine control system is operably connected to engine and powertrain actuators and systems that act to control the engine, in response to the engine operating conditions and operator demands. Typical actuators and systems include, for example, fuel injectors, fuel pump, idle air control valve, exhaust gas recirculation valve, throttle control valve, cam phasing actuator, valve actuators, transmission solenoids, and an exhaust system. A skilled practitioner designs and implements software algorithms and calibrations, which are executed in the electronic controller to monitor the engine operating conditions and operator demands, and control the engine actuators accordingly. The software algorithms and calibrations are typically inserted into software of the engine controller during engine development.

The engine control system includes a fuel system having fuel injectors operable to precisely meter a quantity of fuel to the engine to meet operator demands for power and to meet increasingly stringent emissions requirements. The fuel system for the conventional spark-ignition, multi-cylinder engine typically includes a fuel tank with a fuel pump that is capable of pumping a volume of high pressure fuel through a fuel line to a fuel rail for distribution to a plurality of fuel injectors. In a typical configuration, a fuel injector corresponds to each cylinder of the engine. Each fuel injector is preferably positioned to deliver a quantity of fuel through a runner of an intake manifold of the engine so the fuel is delivered at or near an intake valve to the cylinder. A typical fuel injector comprises a solenoid valve that opens and closes a pintle valve in response to an electrical signal delivered by the engine controller. An injector calibration, in the form of a lookup table or an equation, is inserted into the software of the engine controller for use by the control algorithms. The injector calibration may include, in certain arrangements, a range of mass fuel flow values which correspond to a range of open times of the injector solenoid, as seen by reference to U.S. Pat. No. 7,024,301 issued to Kar et al. entitled METHOD AND APPARATUS TO CONTROL FUEL METERING IN AN INTERNAL COMBUSTION ENGINE, assigned to the common assignee of the present invention, and hereby incorporated by reference in its entirety.

It is also known to provide an engine that is configured to operate on liquid fuel which in one instance comprises gasoline (or 100% gasoline liquid fuel) or in another instance a blend of ethanol and gasoline. In certain markets, engines are also configured to operate on 100% ethanol. In such systems, it is known to configure the software in the electronic controller to use feedback from an exhaust oxygen sensor to estimate the fuel's ethanol content. Once calculated, engine management parameters, such as the amount of fuel injected, spark timing, and cold startup conditions and the like are adjusted automatically. Accordingly, such engine control systems require no special hardware modifications to operate over a range of liquid fuel formulations.

Such multi-fuel (MF) systems have been further modified to accommodate a third fuel type—compressed natural gas (CNG)—to form so-called tri-fuel systems. Certain modification are needed to accommodate CNG fuel including providing another set of fuel injectors for delivering the CNG fuel and a switching box to route the fuel injection signals from the electronic engine controller to either the MF injectors, on the one hand, or to the CNG injectors, on the other hand. However, such a conventional approach does not provide for switching of the signals in a manner synchronized to the timing of the engine crankshaft. Due to this, after an operator request, the change from one type of fuel to the other has to be done when the engine is operating in a condition where the change is less noticed. One reason for this is that as there is less air available for combustion with CNG fuel, the engine develops less power than if running with liquid fuel MF. Therefore, the changeover has to wait until power (e.g., torque) requirements won't exceed torque available with CNG fuel. For example, under wide open throttle (WOT) conditions, the difference between the fuel types is most apparent.

There is therefore a need for an improved method and apparatus for controlling fuel injection that minimizes or eliminates one or more of the problems set forth above.

### SUMMARY OF THE INVENTION

One advantage of the present invention is that it provides for improved driveability compared to current technology implementations. Specifically, the present invention allows the engine management system, for example in high load conditions, to switch from CNG fuel back to liquid fuel when greater torque is needed or desired for improved driveability. This commutation is controlled so as to not disrupt an ongoing fuel injection of CNG fuel.

A method of operating an internal combustion engine according to the invention includes a number of steps. First, providing a fuel type command indicative of a desired fuel type selected from the group comprising a liquid fuel (e.g., multifuel) and compressed natural gas (CNG) fuel. Second, producing a plurality of fuel injection signals defining respective fuel injection events for a corresponding plurality of cylinders of the engine. Finally, switching, in response to the fuel type command, the plurality of fuel injection signals from a first set of injectors to a second, different set of injectors that is associated with the desired fuel type wherein the switching is performed, for each fuel injection signal, after a respective fuel injection event has been completed. The fuel type command is synchronized, in a preferred embodiment, to the engine crankshaft to enable the injector-by-injector changeover.

An apparatus according to the invention is also presented.

Other features and aspects of the invention are further presented.

### BRIEF DESCRIPTION OF THE DRAWINGS

The present invention will now be described by way of example, with reference to the accompanying drawings.

FIG. 1 is a simplified, diagrammatic view of an engine management system according to the invention.

FIG. 2 is an engine torque versus engine speed diagram for both liquid fuel and CNG fuel.

FIG. 3 is a simplified flowchart diagram showing the method of the present invention.

FIG. 4 is a timing diagram for an exemplary four cylinder engine showing the changeover from one fuel type to another fuel type, on an injector-by-injector basis, upon completion of a respective injection event.

FIG. 5 is simplified block diagram showing, in greater detail, an injector selector block of FIG. 1.

### DETAILED DESCRIPTION OF THE PREFERRED EMBODIMENT

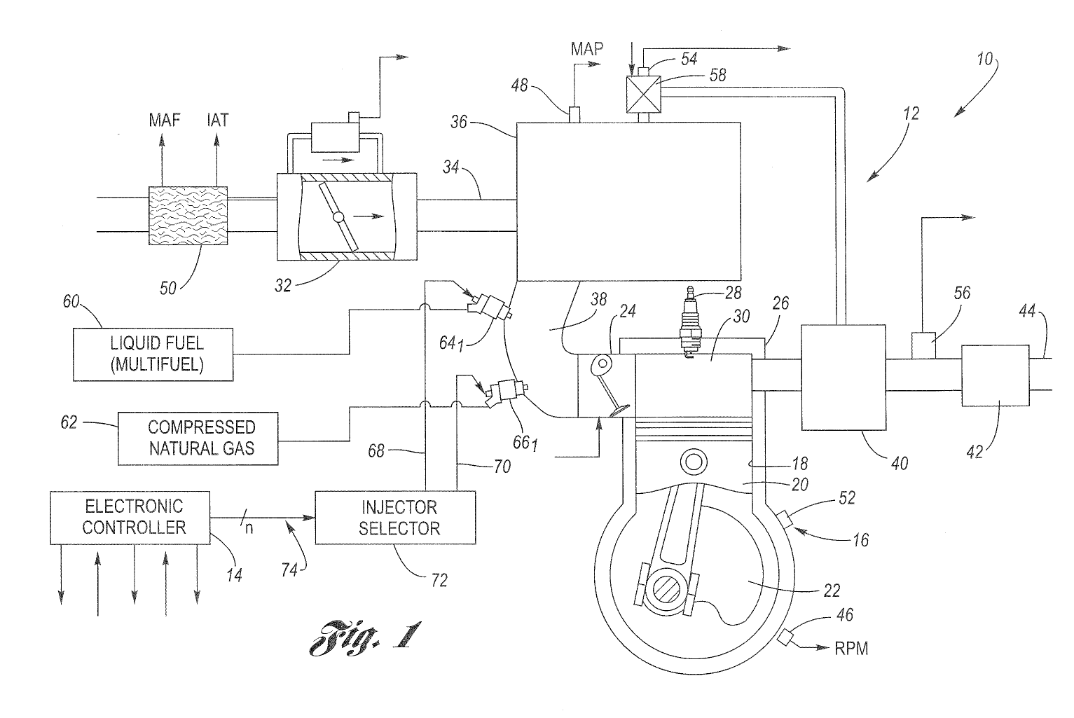

Referring now to the drawings, wherein the Figures are for the purpose of illustrating an embodiment of the invention only, FIG. 1 shows an internal combustion engine system 10 including an internal combustion engine 12 controlled by an electronic engine controller 14, all in accordance with an embodiment of the present invention.

The exemplary internal combustion engine 12 may be a spark-ignition engine that includes base engine components, sensing devices, output systems and devices, and a control system. It should be understood that the principles of the present invention may also be employed in compression ignition type internal combustion engines (e.g., diesel cycle).

Electronic controller 14 is configured via suitable programming to contain various software algorithms and calibrations, electrically connected and responsive to a plurality of engine and vehicle sensors, and operably connected to a plurality of output devices. Controller 14 includes at least one microprocessor, associated memory devices, input devices for monitoring input from external analog and digital devices, and output drivers for controlling output devices. Controller 14 is operable to monitor engine operating conditions and operator inputs using the plurality of sensors, and control engine operations with the plurality of output systems and actuators, using the pre-established algorithms and calibrations that integrate information from monitored conditions and inputs. The software algorithms and calibrations which are executed in the electronic controller 10 may generally comprise conventional strategies known to those of ordinary skill in the art. These programmed algorithms and calibrations are configured, when executed, to monitor the engine operating conditions and operator demands using the plurality of sensors, and control the plurality of engine actuators accordingly. The software algorithms and calibrations are preferably embodied in pre-programmed data stored for use by controller 14.

The base engine components include an engine block 16 with a plurality of cylinders, one of which is shown in FIG. 1 and is designated cylinder 18. Each cylinder 18 contains a respective piston 20 operably attached to a crankshaft 22 at a point eccentric to an axis of rotation of crankshaft 22. There is a head 26 at the top of each piston 20 containing one or more air intake valves 24 and one or more exhaust valves (not shown), and a spark plug 28. A combustion chamber 30 is formed within cylinder 18 between piston 20 and the head 26. An intake manifold is fluidly connected to engine head 26, substantially adjacent air intake valves 24. The intake manifold is connected to an air control valve 32, and includes a common air inlet 34 into a plenum 36, which flows into a plurality of parallel intake runners 38. The plurality of parallel intake runners 38 is preferably formed to permit flow of substantially equal volumes of air from the air control valve 32 to each of the plurality of cylinders 18. An exhaust manifold 40 is fluidly connected to engine head 26, substantially adjacent the exhaust valves, and facilitates flow of exhaust gases away from the engine to exhaust system components 42, 44.

The system 10 includes a variety of sensors. The plurality of sensing devices of the exemplary internal combustion engine 12 are operable to measure ambient conditions, various engine conditions and performance parameters, and operator inputs. Typical sensors include a crankshaft position sensor 46, a camshaft position sensor (not shown), a manifold absolute pressure sensor 48, a throttle position sensor (not shown), a mass air flow sensor 50, an intake air temperature (IAT) sensor (shown as an element of the mass air flow sensor 50), a coolant temperature sensor 52, an exhaust gas recirculation (EGR) position sensor 54, and one or more oxygen sensors or other exhaust gas sensors 56.

The plurality of output systems and devices of the exemplary internal combustion engine 12 are operable to control various elements of engine 12, and include an air intake system, a fuel injection system, an ignition system, an exhaust gas recirculation (EGR) valve 56 and related system, a purge control system (not shown) and exhaust system 42, 44. The air intake system is operable to deliver filtered air to the combustion chamber 30 when the intake valve(s) 24 are open. The air intake system preferably includes an air filtering system fluidly connected to air control valve 32, which is fluidly connected to the intake manifold.

In general terms, one and perhaps the primary function of the fuel control delivery system is to deliver a requisite mass of fuel for a particular fuel type to the engine to meet operator demands while also ensuring the engine meets the requisite emissions requirements. The engine controller 14 is configured to determine a mass amount of fuel to deliver to a cylinder, based upon engine operating conditions and operator demands. Controller 14 is further configured to calculate an amount of time, or pulsewidth, the corresponding fuel injector must be open to deliver the mass amount of fuel to the cylinder, based upon the calibration for a particular fuel type, and other available information. Controller 14 actuates the injector solenoid for the calculated pulsewidth to deliver the appropriate mass amount of fuel. In general, engine controller 14 may typically use correction factors to adjust the calculated pulsewidth to accommodate minor differences caused by variations between engines and engine components, and variations over the life of an engine. Specifically, according to the invention, the controller 14 is configured to also manage fuel type (e.g., liquid fuel and CNG fuel) and associated fuel delivery parameters, as well as manage the changeover transition between the liquid fuel and CNG fuel (described in greater detail below).

In the present invention, multiple fuel sources are provided for, two of which are shown in block form in FIG. 1, namely, a liquid fuel source, designated by reference numeral 60, and a compressed natural gas (CNG) fuel source, designated by reference numeral 62. The liquid fuel source may accommodate one of 100% gasoline liquid fuel, 100% ethanol liquid fuel (in some markets), or a blend of gasoline and ethanol liquid fuels (e.g., commonly available E85 which comprises approximately 85% ethanol and 15% gasoline). The liquid fuel herein may alternatively be referred to as multifuel (e.g., multifuel source, multifuel injectors, MF, etc.). There is a first set of fuel injectors 64 that are configured to deliver liquid fuel to corresponding cylinders of engine 12, one of which is shown in FIG. 1 and is designated 64₁. There is a second set of fuel injectors 66 that are configured to deliver CNG fuel to corresponding cylinders of engine 12, one of which is shown in FIG. 1 and is designated 66₁.

As to the liquid fuel system, each fuel injector 64ᵢ may be placed in a corresponding intake runner 38 at an end of the runner adjacent to the engine head 26, substantially near the intake valve(s) 24 to the cylinder 18. Design of an air intake system, including all of the aforementioned components, is known to one of ordinary skill in the art. The exemplary liquid fuel delivery and injection system comprises the liquid fuel storage tank 60 mentioned above with a high-pressure fuel pump (not shown) that provides fuel to a fuel line and fuel rail (not shown) to deliver liquid fuel to each of the plurality of fuel injectors 64. Each fuel injector 64 is fluidly connected and operable to deliver a quantity of fuel to one of the plurality of intake runners 38. Each fuel injector 64 is controlled according to a respective fuel injection signal generated by the electronic controller 14 and delivered via a respective electrical connection 68. Each fuel injection signal controls the open time of the associated fuel injector. Mechanization of an internal combustion engine, using sensors, output devices, and controller 14 including development of algorithms and calibrations, is known to those of ordinary skill in the art.

As to the CNG fuel system, each fuel injector 66ᵢ may be placed in a corresponding intake runner 38 at an end of the runner adjacent to the engine head 26, substantially near the intake valve(s) 24 to the cylinder 18. Design of an air intake system, including all of the aforementioned components, is known to one of ordinary skill in the art. The exemplary CNG fuel delivery and injection system comprises the CNG fuel storage tank 62 mentioned above and associated delivery apparatus to deliver CNG fuel to each of the plurality of fuel injectors 66. Each fuel injector 66 is fluidly connected and operable to deliver a quantity of natural gas fuel to one of the plurality of intake runners 38. Each fuel injector 66 is controlled according to a fuel injection signal generated by the electronic controller 14 and delivered via a respective electrical connection 70. Each fuel injections signal controls the open time of the associated fuel injector. Mechanization of an internal combustion engine, using sensors, output devices, and controller 14 including development of algorithms and calibrations, is known to those of ordinary skill in the art.

An injector selector 72 is configured for connection to first plurality of fuel injectors 64 (multifuel or MF) and second plurality of fuel injectors (CNG) 66. The injector selector 72 is further configured to switch a plurality of fuel injection signals (collectively designated by reference numeral 74 in FIG. 1) to one of either the first set 64 or second set 66 of fuel injectors, in a manner described in greater detail below.

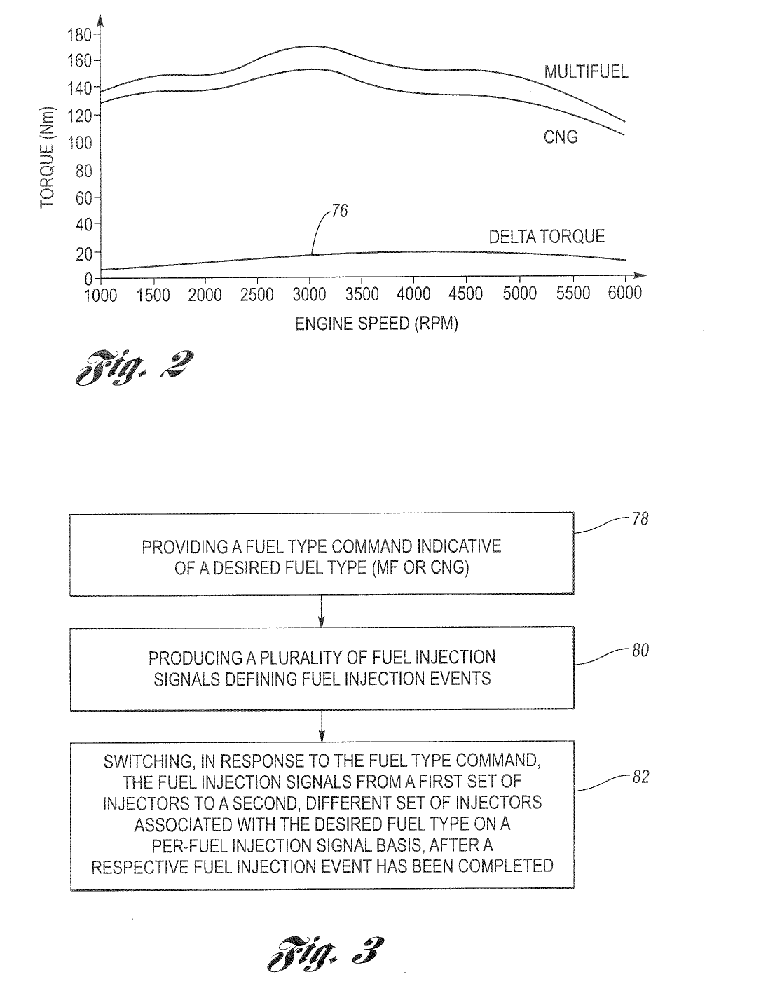

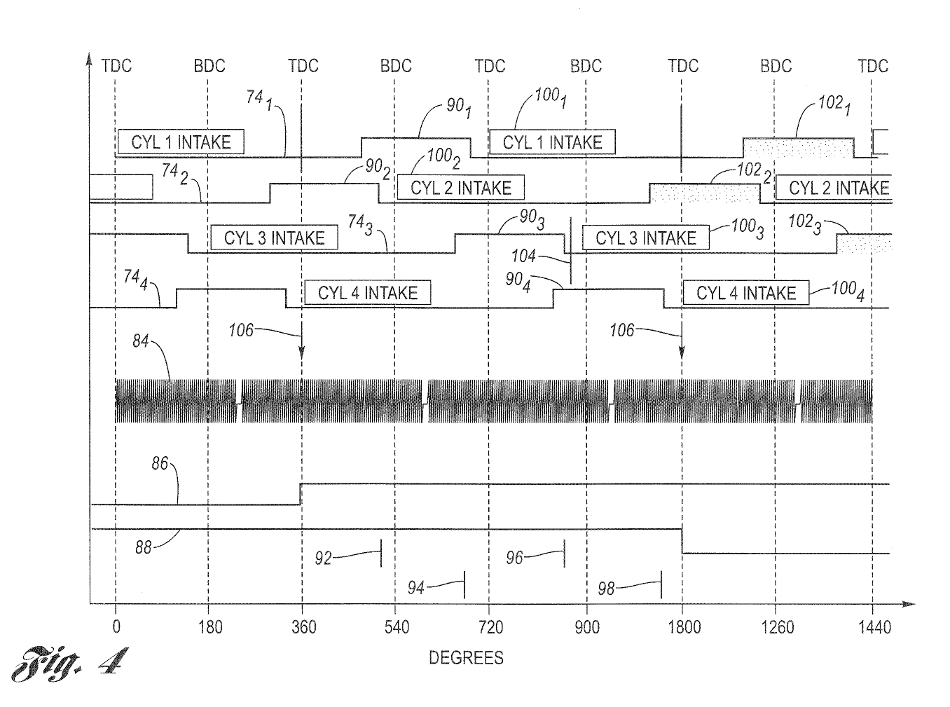

FIG. 2 show a torque versus engine speed diagram for both liquid fuel and CNG. As described in the Background, current engine systems are available that can operate on either multifuel or CNG. However, as there is less air available for combustion with CNG fuel, the engine develops less power (e.g., less torque) than if running on liquid fuel. The difference in power production is specifically shown as trace 76 in FIG. 2.

The present invention allows an engine management system, for example when high load conditions exist, to switch from CNG fuel back to liquid fuel so as to provide greater torque as needed or desired for improved driveability. However, this commutation, according to the invention, does not disrupt the ongoing fuel injection of CNG fuel. Rather, the changeover is controlled to occur systematically, injector by injector, as each injection event is completed.

In accordance with the present invention, a method is provided for operating an internal combustion engine. The method includes a number of steps, and begins with step 78.

Step 78 involves providing a fuel type command indicative of a desired fuel type. The fuel type choices are either multifuel (MF) liquid fuel, as described above, or CNG gas fuel, as also described above. The fuel type command may originate from an input from the operator of the vehicle in which the engine 12 is installed. For example, such input may be obtained by providing a user-actuated button in the vehicle cabin indicative of a desire to switch over to use CNG type fuel. Such input can then be processed by electronic controller 14, which is then further configured to generate the fuel type command, which is more fully described below. Alternatively, electronic controller 14 may be configured, via programming, to detect when predetermined conditions are met where it is needed or desired to changeover to one fuel type or the other. As described above, one such condition may involve detection of high load conditions that are better serviced through the use of liquid fuel, thus necessitating a change if the current operating fuel type is CNG fuel. The electronic controller 14 may be further configured to select the timing of the switchover so as to be less noticeable to the operator (e.g., where liquid fuel and CNG fuel can both achieve similar power production). One of ordinary skill in the art will recognize the many varied other circumstances under which the electronic controller, via its sensor inputs and programming logic, may determine that a fuel type change is needed or desired (e.g., when CNG fuel runs out, necessitating a changeover back to multifuel). The method then proceeds to step 80.

Step 80 involves producing (e.g., calculated by electronic controller 14) a plurality of fuel injection signals each one of which defines a respective fuel injection event for a corresponding cylinder in the engine. The method proceeds to step 82.

Step 82 involves switching, in response to the fuel type command, the fuel injection signals 74 from a first set of injectors to a second, different set of injectors associated with the desired fuel type. The switching is done on an injector-by-injector basis, i.e., each fuel injection signal, when its respective fuel injection event has been completed, will be switched from the injector in the first set and routed to the corresponding injector in the second set of injectors set to deliver fuel of the desired fuel type. The actual switching is performed by injector selector 72 (greater detail below), which reroutes the fuel injection signals thereby swapping the injectors, one by one, after the respective fuel injection event for each cylinder has ended.

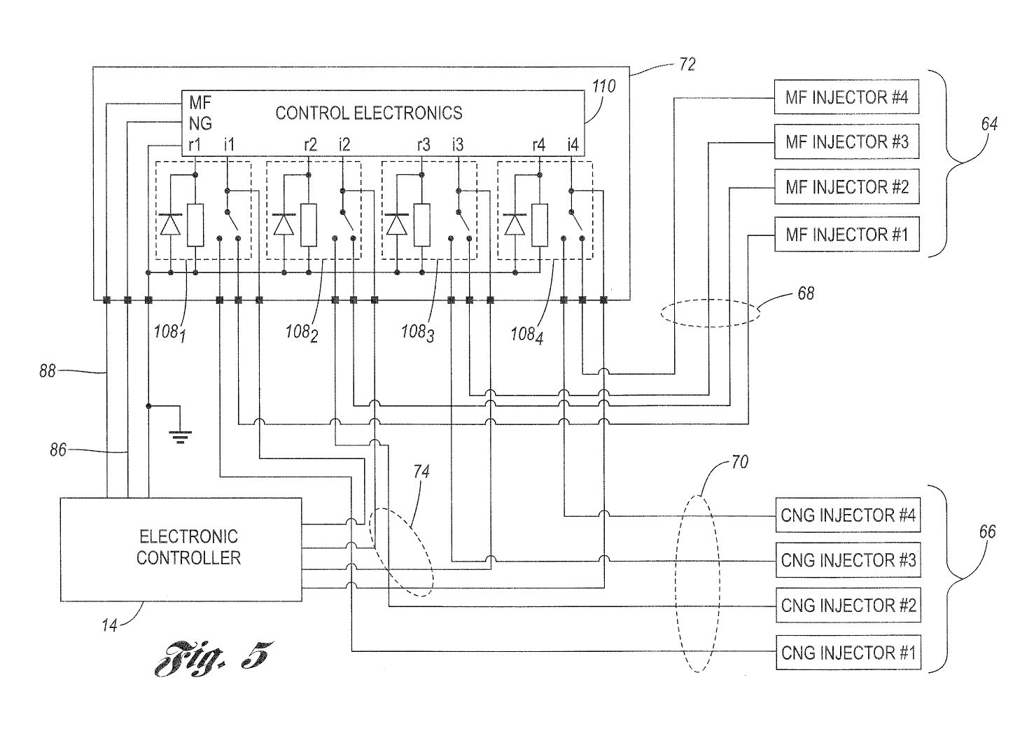

FIG. 4 is a timing diagram showing, for an exemplary four-stroke, four cylinder engine, the specific timing relationships contemplated by the present invention. The X-axis is described in terms of a crankshaft position (e.g., degrees), with major ticks every 180 degrees (one-half revolution of one crankshaft, or one-quarter of an engine cycle). The fuel injection signals from electronic controller 14 (i.e., signals 74 from FIG. 1) are shown for each cylinder, and are designated 74₁, 74₂, 74₃ and 74₄, where the subscript indicates the corresponding cylinder number. FIG. 4 also shows an engine crankshaft position signal 84 (e.g., from sensor 46 in FIG. 1), which is a signal indicative of and from which the crankshaft angular position is and/or may be determined. FIG. 4 further shows a CNGR signal 86, which is an electrical signal indicative of a request to use CNG type fuel. FIG. 4 also shows a multifuel (MF) signal 88, which is indicates that at least one cylinder/injector continue to operate on liquid fuel (multifuel). CNGR signal 86 and MF signal 88, collectively, are processed to determine the desired fuel type, and hence collectively define, in this embodiment, the fuel type command.

For each one the fuel injection signals 74₁, 74₂, 74₃ and 74₄, there is a corresponding fuel injection pulse, designated 90₁, 90₂, 90₃ and 90₄, having a pulsewidth corresponding to the time in which the respective fuel injector is delivering fuel of the desired type destined for the combustion chamber. As described above, the fuel injection signals 74₁, 74₂, 74₃ and 74₄, are switched away from the injectors using the original fuel type to the corresponding injectors using the desired fuel type. This commutation occurs at the end of the respective fuel injection event, on an injector-by-injector basis.

In the example of FIG. 4, the original fuel type is liquid fuel (multifuel-MF), while the desired, destination fuel type is CNG fuel. Accordingly, as shown near the bottom of FIG. 4, the CNGR signal 86 is initially low (CNG fuel not requested), while the MF signal 88 is initially high. At around 360 degrees, the CNGR signal 86 is asserted, which is indicated by a transition from a low logic state to a high logic state. As shown near the bottom of FIG. 4, the first injector to complete its fuel injection event, after the CNGR signal 86 has been asserted, is the injector for cylinder two. Accordingly, a timing mark 92 is shown that indicates the approximate time in which the fuel injection signal for cylinder #2 is switched away from the MF fuel injector to the corresponding CNG fuel injector. FIG. 4 further shows timing/commutation marks 94, 96 and 98 for the remaining cylinder nos. #1, #3 and #4, respectively.

A constructed embodiment (FIG. 5) of injector selector 72 employs electromechanical switches (e.g. relays) to perform the switching function. Therefore, during the time immediately after commutation, namely, during most of the intake stroke portion of the engine cycle, designated 1001, 1002, 1003 and 1004, for the four cylinders, there will be no fuel injection and the relays will be allowed to stabilize in their new positions. For the next fuel injection event, respectively designated 102₁, 102₂, 102₃ and 102₄ (the next injection for cylinder 4 not shown in FIG. 4), the desired fuel will be delivered by the injectors to the engine.

In accordance with another aspect of the present invention, the CNG request signal (CNGR signal 86) is updated synchronously to engine speed at a so-called “End of Injection Target” (EOIT) time 104, which in one embodiment is a predetermined number of degrees (e.g., 500 degrees) after Top Dead Center (TDC). The reference TDC times are shown as times 106. In a preferred embodiment, electronic controller 14 is configured to keep track of the status of the fuel being used in each cylinder, for example, when fuel type changes occur as described above, and associate this status data with each cylinder/injector. Accordingly, controller 14 is further configured to calculate an appropriate pulsewidth for the next fuel injection events 102₁, 102₂, 102₃ and 102₄ which reflect the new fuel type. In another aspect, controller 14 is further configured to detect when the fuel type is changing from CNG fuel to liquid fuel, and, computing a predetermined additional amount of fuel (in addition to the base amount) for a predetermined time to account for wall wetting effect of the liquid fuel.

FIG. 5 shows a simplified block diagram of injector selector 72. In one embodiment, the switching function is performed using electromechanical switches such as relays 108₁, 108₂, 108₃ and 108₄ (shown enclosed in dashed-line boxes). Injector selector 72 further includes control electronics 110 configured to implement the logic of switching the fuel injection signals 74₁, 74₂, 74₃ and 74₄, one by one, in accordance with the CNGR signal 86 and the MF signal 88 (the fuel type command). Each relay 108₁, 108₂, 108₃ and 108₄ is configured to switch the respective fuel injection signal 74₁, 74₂, 74₃ and 74₄, for routing to one of the injectors in either the first set of injectors 64 (MF) or the second set of injectors 66 (CNG). The control electronics 110 may be configured in accordance with the logic described in Table 1 below. The term rᵢ, where i=1, 2, 3 or 4 correspond to the injector for that cylinder number, indicates whether the relay will route the fuel injection signal to the MF injector (r=0) or to the CNG injector (r=1).

TABLE 1
Logic table for injector selector 72.

| MF | CNGR | Ix | Rx Prev | Rx Next |
|---|---|---|---|---|
| 0 | 0 | X | X | 0 (MF) |
| 0 | 1 | X | X | 1 (NG) |
| 1 | 0 | X | X | 0 (MF) |
| 1 | 1 | / | 0 | 1 (NG) |
| 1 | 1 | / | 1 | 0 (MF) |

In Table 1, the “/” symbol indicates a transition for Low->High.

It should be understood that electromechanical switches need not be used in selector 72, and that other switching mechanisms are known to those of ordinary skill in the art and may be aptly substituted therefore. Furthermore, while the CNGR signal 86 is shown as being developed by controller 14, other circuitry or arrangements are possible to synchronize a CNGR signal with the engine crankshaft position.

It will be appreciated that in one embodiment, a vehicle may be originally manufactured to perform substantially as described above to operate as a tri-fuel vehicle (i.e., multifuel and CNG fuel capable).

It will be further appreciated that in another embodiment, a vehicle may be originally manufactured to be multifuel capable, but electronic controller 14 may be nonetheless further configured for tri-fuel operation (i.e., both multifuel or CNG fuel). In such an embodiment, an owner/operator or other individual may obtain an aftermarket kit that includes CNG injectors and an injector selector 72, where after full installation, a complete tri-fuel capable vehicle, as fully described above, is obtained.

It should be understood that the functionality described herein performed by controller 14 may be implemented, in one embodiment, by suitable programming of controller 14, and that this enabling disclosure will enable one of ordinary skill in the art to undertake such configuration by programming.

While particular embodiments of the invention have been shown and described, numerous variations and alternate embodiments will occur to those skilled in the art. Accordingly, it is intended that the invention be limited only in terms of the appended claims.

1. A method of operating an internal combustion engine, comprising the steps of:
providing a fuel type command indicative of a desired fuel type selected from the group comprising a liquid fuel and a compressed natural gas (CNG) fuel;
producing a plurality of fuel injection signals defining fuel injection events for a corresponding plurality of cylinders of the engine; and
switching, in response to the fuel type command, said plurality of fuel injection signals from a first set of injectors to a second, different set of injectors associated with the desired fuel type wherein said switching is performed, for each fuel injection signal, after a respective fuel injection event has been completed.

2. The method of claim 1 wherein said step of providing a fuel type command includes the substeps of:
generating a liquid fuel command signal;
generating a CNG fuel request signal in synchronism with a rotational position of a crankshaft of the engine.

3. The method of claim 2 wherein said step of providing a fuel type command further includes the substep of:
providing the liquid fuel command signal and the CNG request signal simultaneously to an injector selector.

4. The method of claim 1 wherein said step of providing the fuel type command includes the substeps of:
receiving an input from an operator of a vehicle in which the engine is installed indicative of a desired fuel type;
synchronizing the input from the operator in accordance with a crankshaft position signal.

5. The method of claim 4 wherein said step of receiving the input from the operator includes the substep of:
providing a manually-actuated button whose actuation is indicative of a desired fuel type, wherein the desired fuel type comprises CNG fuel.

6. The method of claim 1 wherein said step of providing the fuel type command includes the substeps of:
determining when predetermined operating conditions are present indicative of a desire to use liquid fuel and configuring the fuel type command for liquid fuel;
synchronizing the fuel type command in accordance with a crankshaft position signal.

7. The method of claim 1 wherein said step of generating a plurality of fuel injection signals includes the substeps of:
calculating, for each one of the plurality of fuel injection signals, a respective pulsewidth corresponding to an amount of fuel of the desired fuel type to be delivered to the corresponding cylinder of the engine.

8. The method of claim 7 wherein the respective amounts of fuel are determined, when the desired fuel type corresponds to liquid fuel, in accordance with wall wetting effects.

9. The method of claim 7 wherein the fuel injection events are completed when the pulsewidth ends.

10. The method of claim 1 wherein said internal combustion engine is a spark-ignited internal combustion engine.

11. The method of claim 10 wherein said engine comprises a four-stroke otto cycle engine.

12. The method of claim 1 wherein said internal combustion engine is a compression internal combustion engine.

13. The method of claim 1 wherein the liquid fuel comprises one of a gasoline liquid fuel and a gasoline and ethanol blend liquid fuel.

14. An assembly for use with an engine system that includes a first plurality of fuel injectors configured to deliver liquid fuel to corresponding cylinders of the engine wherein the engine is further configured to operate on compressed natural gas (CNG) fuel, comprising:
a second plurality of fuel injectors configured to deliver CNG fuel to corresponding cylinders of the engine;
an injector selector configured for connection to the first plurality of fuel injectors and the second plurality of fuel injectors, said injector selector being configured to switch a plurality of fuel injection signals to one of the first and second plurality of fuel injectors in dependence on a fuel type command that is indicative of a desired fuel type, said desired fue type being selected from the group comprising liquid fuel and CNG fuel, said injector selector being configured for switching each fuel injection signal after a respective fuel injection event has been completed, said fuel type command being synchronized in accordance with a crankshaft position signal indicative of a crankshaft position.
